(19) United States
(12) Patent Application Publication
(10) Pub. No.: US 2021/0253103 A1
(43) Pub. Date: Aug. 19, 2021

(54) METHOD, SYSTEM, AND DEVICE FOR DETERMINING OVERTAKING TRAJECTORY FOR AUTONOMOUS VEHICLES

(71) Applicant: Wipro Limited, Bangalore (IN)

(72) Inventors: Balaji Sunil KUMAR, Bengaluru (IN); Manas SARKAR, Kolkata (IN)

(21) Appl. No.: 16/835,435

(22) Filed: Mar. 31, 2020

(30) Foreign Application Priority Data
Feb. 17, 2020 (IN) 202041006838

(51) Int. Cl. B60W 30/18; G05D 1/02; B60W 60/00

(52) U.S. Cl. CPC B60W 30/18163; B60W 60/0015; G05D 1/0212

(57) ABSTRACT

A method and system for determining overtaking trajectory for autonomous vehicles is disclosed. The method includes determining a plurality of dynamic separation distances of an autonomous vehicle from a first vehicle ahead of the autonomous vehicle at predefined time intervals over a period of time. The method further includes generating a trigger for the autonomous vehicle to overtake the first vehicle, when the dynamic separation distance is below a first distance threshold and a current velocity of the autonomous vehicle is greater than a current velocity of the first vehicle. The method further includes determining an overtaking velocity and an overtaking distance for the autonomous vehicle. The method further includes determining an available overtaking region for the autonomous vehicle. The method further includes generating a trajectory for the autonomous vehicle to overtake the first vehicle based on the overtaking distance.

### TECHNICAL FIELD

This disclosure relates generally to autonomous vehicles, and more particularly to method and system for determining overtaking trajectory for autonomous vehicles.

### BACKGROUND

Autonomous vehicles may be equipped with multiple sensors and control arrangements for enabling its autonomous operation to initiate an autonomous drive. The sensors, for example, may be camera sensors, radar sensors and/or Lidar sensors. These sensors are built to constantly sense the surrounding environment of autonomous vehicles in order to identify a long-distance global path for enabling secure navigation. However, when autonomous vehicles drive along a global path on a road, a scenario may occur with the need for overtaking a vehicle ahead of an autonomous vehicle.

Conventionally, a common technique adopted by autonomous vehicles for overtaking is a lane change method. While the lane change method may have fewer complexities, but it may not be the most desirable method to be adopted on a highway scenario, as the highway scenario includes speed limits for different types of vehicles and sometime also for lanes. Additionally, the conventionally available technique may not be capable of determining a free region ahead of front moving vehicle and on adjacent lanes of autonomous vehicles over a certain time. Therefore, a method is needed for trajectory adjustment without the limitations of the conventional techniques.

### SUMMARY

In an embodiment, a method for determining an overtaking trajectory for autonomous vehicles is disclosed. In one embodiment, the method may include determining, by a trajectory determining device, a plurality of dynamic separation distances of an autonomous vehicle from a first vehicle ahead of the autonomous vehicle at predefined time intervals over a period of time. The first vehicle and the autonomous vehicle are on a first lane. The method may further include generating, by the trajectory determining device, a trigger for the autonomous vehicle to overtake the first vehicle, when the dynamic separation distance at a current time instance is below a first distance threshold and a current velocity of the autonomous vehicle is greater than a current velocity of the first vehicle. The method may further include determining, by the trajectory determining device, an overtaking velocity and an overtaking distance for the autonomous vehicle based on the plurality of separation distances determined over the period of time. The method may further include determining, by the trajectory determining device, an available overtaking region for the autonomous vehicle, based on at least one dimension feature associated with at least one adjacent lane and a region ahead of the first vehicle on the first lane. The at least one dimension feature is generated based on a set of parameters received from at least one of a plurality of sensors. The method may further include generating, by the trajectory determining device, a trajectory for the autonomous vehicle to overtake the first vehicle based on the overtaking distance, when the available overtaking region is above a second distance threshold. The trajectory comprises a plurality of portions and a first portion from the plurality of portions is at a predefined distance from the first lane.

In another embodiment, a system for determining an overtaking trajectory for autonomous vehicles is disclosed. The system includes a processor and a memory communicatively coupled to the processor, wherein the memory stores processor instructions, which, on execution, causes the processor to determine, a plurality of dynamic separation distances of an autonomous vehicle from a first vehicle ahead of the autonomous vehicle at predefined time intervals over a period of time, wherein the first vehicle and the autonomous vehicle are on a first lane. The processor instructions further causes the processor to generate a trigger for the autonomous vehicle to overtake the first vehicle, when the dynamic separation distance at a current time instance is below a first distance threshold and a current velocity of the autonomous vehicle is greater than a current velocity of the first vehicle. The processor instructions further cause the processor to determine an overtaking velocity and an overtaking distance for the autonomous vehicle based on the plurality of separation distances determined over the period of time. The processor instructions further causes the processor to determine an available overtaking region for the autonomous vehicle, based on at least one dimension feature associated with at least one adjacent lane and a region ahead of the first vehicle on the first lane, wherein the at least one dimension feature is generated based on a set of parameters received from at least one of a plurality of sensors. The processor instructions further causes the processor to generate a trajectory for the autonomous vehicle to overtake the first vehicle based on the overtaking distance, when the available overtaking region is above a second distance threshold, wherein the trajectory comprises a plurality of portions and a first portion from the plurality of portions is at a predefined distance from the first lane.

In yet another embodiment, a non-transitory computer-readable storage medium is disclosed. The non-transitory computer-readable storage medium has instructions stored thereon, a set of computer-executable instructions causing a computer comprising one or more processors to perform steps comprising determining, a plurality of dynamic separation distances of an autonomous vehicle from a first vehicle ahead of the autonomous vehicle at predefined time intervals over a period of time, wherein the first vehicle and the autonomous vehicle are on a first lane; generating a trigger for the autonomous vehicle to overtake the first vehicle, when the dynamic separation distance at a current time instance is below a first distance threshold and a current velocity of the autonomous vehicle is greater than a current velocity of the first vehicle; determining an overtaking velocity and an overtaking distance for the autonomous vehicle based on the plurality of separation distances determined over the period of time; determining, by the trajectory determining device, an available overtaking region for the autonomous vehicle, based on at least one dimension feature associated with at least one adjacent lane and a region ahead of the first vehicle on the first lane, wherein the at least one dimension feature is generated based on a set of parameters received from at least one of a plurality of sensors; and generating, by the trajectory determining device, a trajectory for the autonomous vehicle to overtake the first vehicle based on the overtaking distance, when the available overtaking region is above a second distance threshold, wherein the trajectory comprises a plurality of portions and a first portion from the plurality of portions is at a predefined distance from the first lane.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary environment in which various embodiments may be employed.

FIG. 2 is a block diagram illustrating a system for determining an overtaking trajectory for an autonomous vehicle, in accordance with an embodiment.

FIG. 3 illustrates a functional block diagram of various modules within a memory of a trajectory determining device configured to determine an overtaking trajectory for an autonomous vehicle, in accordance with an embodiment.

FIG. 4 illustrates a flowchart of a method for determining an overtaking trajectory for an autonomous vehicle, in accordance with an embodiment.

FIG. 5 illustrates determination of overtaking velocity and an overtaking distance based on a graph that represents separation distance versus time for an autonomous vehicle and a first vehicle, in accordance with an exemplary embodiment.

FIG. 6 illustrates a Light Detection and Ranging (LiDAR) point reflection depicting a free road region availability for overtaking a first vehicle by an autonomous vehicle, in accordance with an exemplary embodiment.

FIG. 7 illustrates a flowchart of a method for modifying an overtaking velocity of an autonomous vehicle, in accordance with an embodiment.

FIG. 8 illustrates determination of a trapezoidal overtaking trajectory for an autonomous vehicle with respect to a base global path, in accordance with an exemplary embodiment.

FIG. 9 illustrates a flowchart of a method for determining a trigger to abort overtaking maneuver by an autonomous vehicle, in accordance with an embodiment.

FIG. 10 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

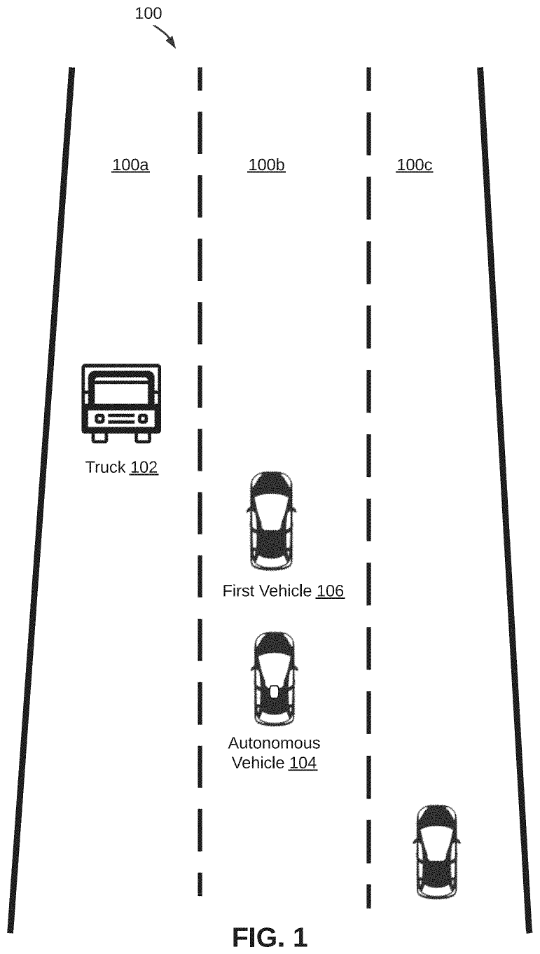

An exemplary environment 100 in which various embodiments may be employed, is illustrated in FIG. 1. The environment 100 depicts a section of a highway that includes three lanes, i.e., a lane 100a, a lane 100b, a lane 100c. Each of the lanes 100a-100c may have an associated speed limit for different type vehicles moving on the highway. The environment 100 may further include a truck 102 moving in the lane 100a (i.e., the leftmost lane) at a slow speed and an autonomous vehicle 104 (also referred to as an autonomous ground vehicle (AGV)) moving behind a first vehicle 106 (front vehicle), in the lane 100b (i.e., the central lane). In an exemplary scenario, the autonomous vehicle 104 may be moving at a certain speed that conforms with permissible speed limit for the lane 100b. Additionally, the first vehicle 106 may be moving at a speed that is lower than that of the autonomous vehicle 104. Thus, rather than moving into adjacent lanes, i.e., the lanes 100a and 100c, the autonomous vehicle 104 may want to overtake the first vehicle 106 via one of the lanes 100a and 100c and then come back to the lane 100b for further motion. Thus, in such a situation, the autonomous vehicle 104 may try to find an opportunity for overtaking the first vehicle 106. To this end, the autonomous vehicle 104 may temporarily occupy a vacant highway portion available on either of the adjacent lanes, i.e., lanes 100a and 100c, and may again come back to the lane 100b, i.e., the central lane. It will be apparent to a person skilled in the art that the above scenario is merely exemplary and various other scenarios may necessitate such overtaking maneuver by the autonomous vehicle 104.

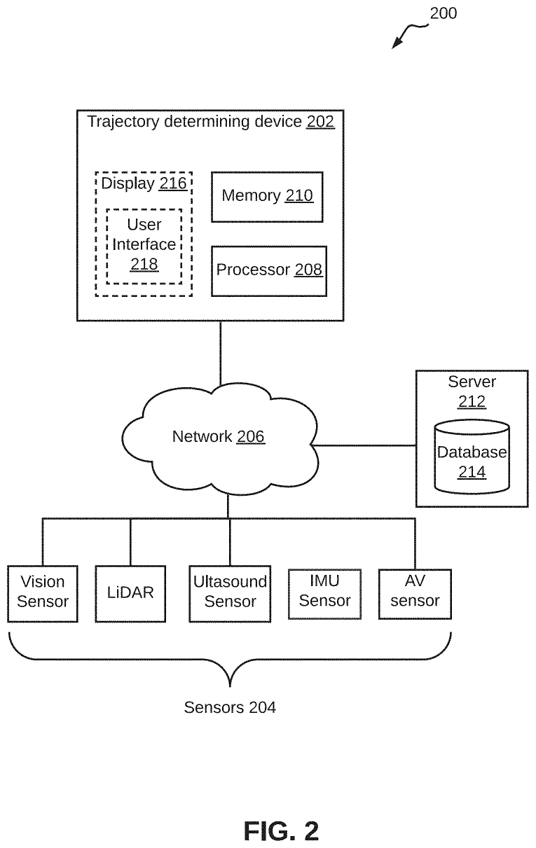

Referring now to FIG. 2, a system 200 for determining an overtaking trajectory for the autonomous vehicle 104 is illustrated, in accordance with an embodiment. The system 200 may include a trajectory determining device 202 that has processing capabilities for generating a trajectory for overtaking the first vehicle 106 ahead of the autonomous vehicle 104. The trajectory determining device 202 may be integrated within the autonomous vehicle 104 or may be located remotely from the autonomous vehicle 104. Examples of the trajectory determining device 202 may include, but are not limited to a car dashboard, an application server, a desktop, a laptop, a notebook, a netbook, a tablet, a smartphone, or a mobile phone.

The trajectory determining device 202 may generate the trajectory based on a trigger generated for overtaking the first vehicle 106 ahead of the autonomous vehicle 104. In order to generate the trigger, the trajectory determining device 202 may continuously monitor a dynamic separation distance between the autonomous vehicle 104 and the first vehicle 106. The trajectory determining device 202 may additionally monitor a current velocity of the autonomous vehicle 104 and the first vehicle 106. The trajectory determining device 202 may receive the dynamic separation distance and the current velocity of the autonomous vehicle 104 and the first vehicle 106 from a plurality of sensors 204 placed at various locations within the autonomous vehicle 104. By way of an example, the plurality of sensors 204 may include, but are not limited to, a vision sensor, an Autonomous Vehicle (AV) sensor, an ultrasound sensor, an Inertial Measurement Unit (IMU) sensor, and a Light Detection and Ranging (LiDAR) sensor. The plurality of sensors 204 may be communicatively coupled to the trajectory determining device 202, via a network 206. The network 206 may be a wired or a wireless network and the examples may include, but are not limited to the Internet, Wireless Local Area Network (WLAN), Wireless Fidelity (Wi-Fi), Long Term Evolution (LTE), Worldwide Interoperability for Microwave Access (WiMAX), Fifth Generation (5G) network, and General Packet Radio Service (CPRS).

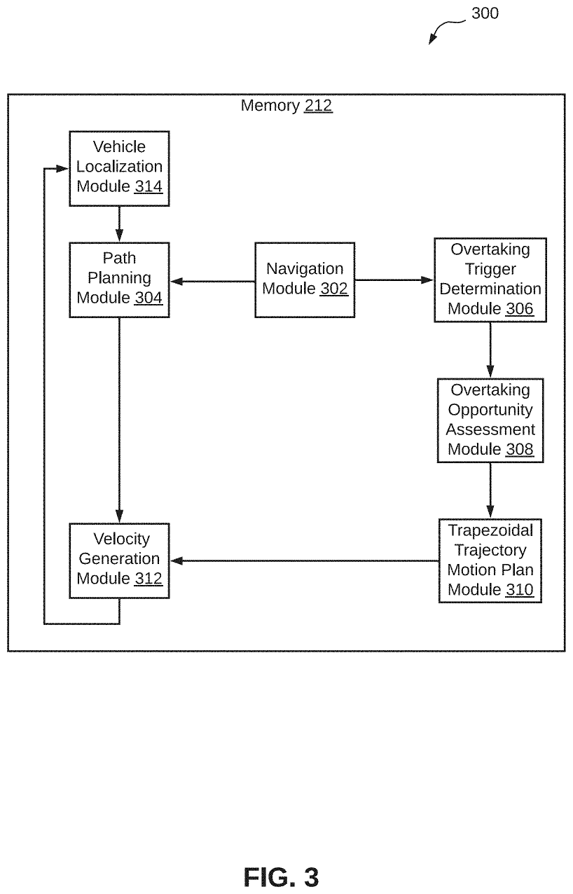

As will be described in greater detail in conjunction with FIG. 3 to FIG. 9, in order to determine the overtaking trajectory for the autonomous vehicle 104, the trajectory determining device 202 may include a processor 208, which may be communicatively coupled to a memory 210. The memory 210 may store process instructions, which when executed by the processor 208 may cause the processor 208 to determine the overtaking trajectory for the autonomous vehicle 104. This is further explained in detail in conjunction with FIG. 3. The memory 210 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random-Access Memory (DRAM), and Static Random-Access memory (SRAM).

In an embodiment, in response to the trigger, the trajectory determining device 202 may extract a set of trajectory parameters from a server 212, via the network 206, in order to identify an available overtaking region for the autonomous vehicle 104. The set of trajectory parameters may include, at least one of a slope of the trajectory, an alignment of the trajectory, a curvature of the trajectory, and a road roughness associated with the trajectory. It will be apparent to a person skilled in the art that the server 212 may be remotely located, such that, the server 212 may be accessed by multiple autonomous vehicles at any given time. In one implementation, the server 212 may be located within the autonomous vehicle 104. This is further explained in detail in conjunction with FIG. 3. The server 212 may include a database 214 that may be updated periodically with a new set of trajectory parameters associated with various trajectories generated for overtaking, over time.

The trajectory determining device 202 may further include a display 216 that may further include a user interface 218. A user or an administrator may interact with the trajectory determining device 202 and vice versa through the display 216. The display 216 may be used to display various results (intermediate or final) that may be used while performing an overtaking maneuver by the autonomous vehicle 104. The user interface 218 may be used by the user to provide inputs to the trajectory determining device 202.

Referring now to FIG. 3, a functional block diagram of various modules within the memory 210 of the trajectory determining device 202 configured to determine the overtaking trajectory for the autonomous vehicle 104 is illustrated, in accordance with an embodiment. As explained in conjunction with FIG. 2, the trajectory determining device 202 may generate a trajectory based on a trigger for the autonomous vehicle 104 to overtake the first vehicle 106 ahead of the autonomous vehicle 104. The memory 210 may include a navigation module 302, a path planning module 304, an overtaking trigger determination module 306, an overtaking opportunity assessment module 308, a trapezoidal trajectory motion plan module 310, a velocity generation module 312, and a vehicle localization module 314. As will be appreciated by those skilled in the art, all such aforementioned modules 302-314 may be represented as a single module or a combination of different modules. Moreover, as will be appreciated by those skilled in the art, each of the modules 302-314 may reside, in whole or in parts, on one device or multiple devices in communication with each other.

In an embodiment, the navigation module 302 may act as a user interface for displaying a navigation map to a user of the autonomous vehicle 104. The navigation map displayed may enable the user to see a current initial location (also referred as source point) of the autonomous vehicle 104. In addition, the user may touch any point on the navigation map displayed via the user interface to select a destination point and initiate the navigation process for the autonomous vehicle 104 from its current location. The navigation process may include path planning and velocity generation to autonomously drive the autonomous vehicle 104 to the destination point. By way of an example, the navigation module 302 may provide a part of the global path to the autonomous vehicle 104, in order to initiate motion of the autonomous vehicle 104 from the current location. The part of the global path may include a navigation path of 10 to 20 meters ahead of the autonomous vehicle 104.

The path planning module 304 may produces a base path that is to be used for navigation of the autonomous vehicle 104 from the current initial location to the destination point. To this end, the path planning module 304 may include a path planning algorithm, for example, a Dijkstra or A*. The base path may be produced on a 2D occupancy grid map. For motion of the autonomous vehicle 104, the path planning module 304 may generate a part of the base path that is 10 to 15 meters distance from the current initial position of the autonomous vehicle 104. The path planning module 304 may also generate a suitable trajectory plan for this part of the base path, based on current environment data and speed of the autonomous vehicle 104. The path planning module 304 may share a trajectory plan with the velocity generation module 312 and the navigation module 302 for velocity generation.

The overtaking trigger determination module 306 may keep on monitoring a plurality of dynamic separation distances of the autonomous vehicle 104 from the first vehicle 106 at predefined intervals over a period of time. In an embodiment, the autonomous vehicle 104 and the first vehicle 106 may be moving in a same lane (for example, the lane 100b). In order to monitor the dynamic separation distance, the overtaking trigger determination module 306 may use a vision sensor. The vision sensor may correspond to a camera that may capture an image of the first vehicle 106 ahead of the autonomous vehicle 104. The overtaking trigger determination module 306 may identify whether a current velocity of the autonomous vehicle 104 is higher than that of the first vehicle 106.

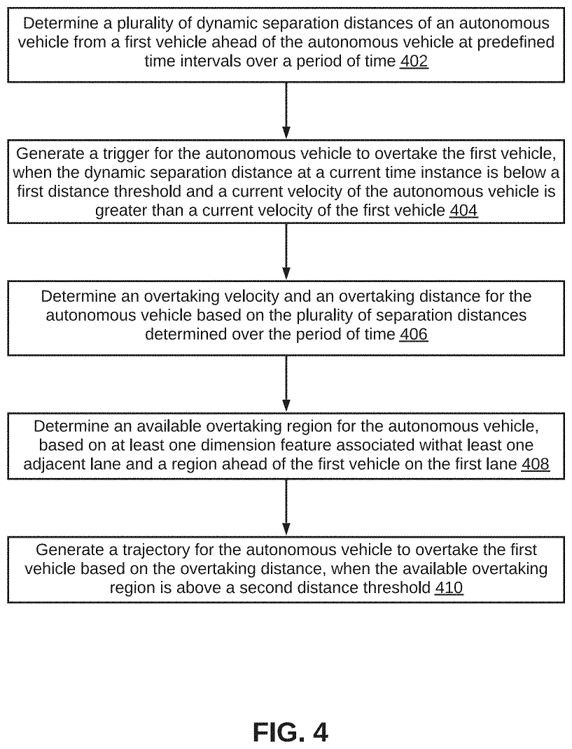

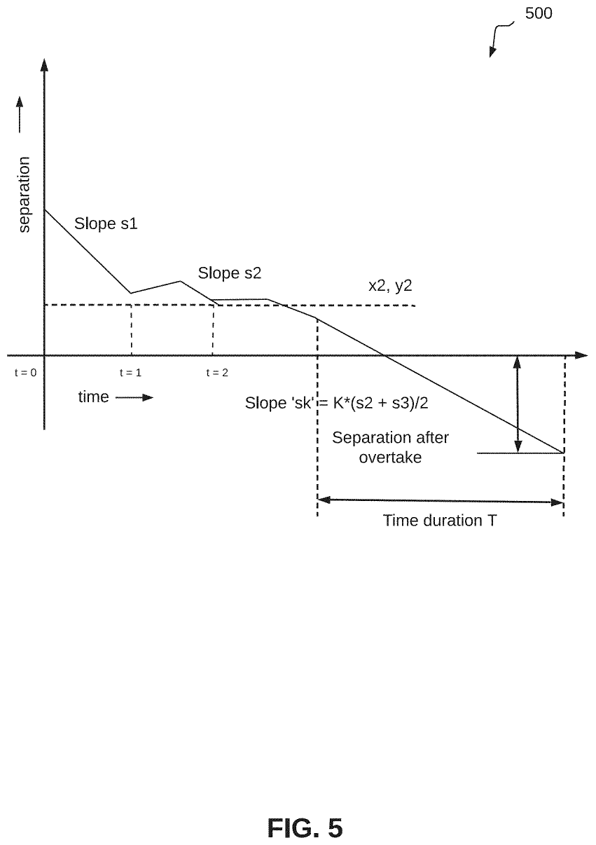

The overtaking trigger determination module 306 may then analyze the plurality of dynamic separation distances and the current velocity. Based on analysis, the overtaking trigger determination module 306 may generate a trigger for the autonomous vehicle 104 to overtake the first vehicle 106. Also, the overtaking trigger determination module 306 in the meanwhile may adjust the current velocity of the autonomous vehicle 104 in order to remain behind and follow the first vehicle 106 on the same lane. The method to analyse the plurality of dynamic separation distances and the current velocity is further explained in detail in conjunction with FIG. 4 and FIG. 5.

Once the trigger is generated, in order to execute overtaking, the overtaking opportunity assessment module 308 may identify an available overtaking region based on data captured by various sensors (for example, the plurality of sensors 204). The available overtaking region may correspond to a free road region available for overtaking. Examples of the plurality of sensors may include, but is not limited to a vision sensor, an AV sensor, a LIDAR, an IMU sensor, and an ultrasound sensor. The free road region identified by the overtaking opportunity assessment module 308 may include an available region ahead of the first vehicle and an available region on at least one of the adjacent lanes (lanes 100a and 100c) with respect to the first vehicle. Also, the overtaking opportunity assessment module 308 may make certain that an adjacent lane (for example, the lane 100c) must be empty up to a certain distance behind the autonomous vehicle 104 in order to ensure that no high-speed vehicle may reach in close proximity to the autonomous vehicle 104. The method to identify the available overtaking region is explained in detail in conjunction with FIG. 4 to FIG. 6.

Once the available overtaking region is identified, the trapezoidal trajectory motion plan module 310 may plan a trajectory for the autonomous vehicle 104 to enable the autonomous vehicle 104 to overtake the first vehicle 106 based on the available overtaking region. The trajectory planned for overtaking may be a trapezoidal trajectory that may include a lane change, a high speed move, and a comeback lane change trajectory. Moreover, the trajectory planned for overtaking may not be for a fixed distance, but rather may be a fixed time period trajectory, considering that other vehicle move at different speeds on the highway. The method for generating the trapezoidal trajectory for overtaking the first vehicle 106 ahead of the autonomous vehicle 104 is explained in detail in conjunction with FIG. 4 to FIG. 7

Based on inputs received from the trapezoidal trajectory motion plan module 310, the velocity generation module 312 may generate a realistic velocity for the autonomous vehicle 104 based on a preceding velocity and a projected velocity as per the trajectory plan based on a trajectory-velocity plan. In an embodiment, while the trajectory is planned, based on the current velocity of the autonomous vehicle 104 and global path segment ahead of the first vehicle 106, the velocity generation module 312 may receive better trajectory suggestion for overtaking. Additionally, the velocity generation module 312 may generate the realistic velocity at a predefined frequency, for example, “100 ms”. This velocity may then be applied to wheelbase of the autonomous vehicle 104. The velocity generation module 312 may additionally analyze a next moment velocity of the autonomous vehicle 104 for calculation of realistic velocity for the autonomous vehicle 104. This is further explained in detail in conjunction with FIG. 4-FIG. 9.

The vehicle localization module 314 may determine a current position of the autonomous vehicle 104 on the navigation map based on inputs received from the path planning module 304, the navigation module 302, and the velocity generation module 312. The inputs received by the vehicle localization module 314 may include position and orientation of the autonomous vehicle 104 received from at least one of the plurality of sensors. Based on the position determined by the vehicle localization module 212, the autonomous vehicle 104 may proceed on a next portion of the trajectory plan with a suitable velocity.

Referring now to FIG. 4, a flowchart of a method for determining an overtaking trajectory for the autonomous vehicle 104 is illustrated, in accordance with an embodiment. At step 402, a plurality of dynamic separation distances of the autonomous vehicle 104 from the first vehicle 106 may be determined at predefined time intervals over a period of time. As explained in FIG. 1, the first lane may correspond to the central lane, i.e., the lane 100b.

In an embodiment, in order to determine the plurality of dynamic separation distances, the autonomous vehicle 104 may first render a bounding box at a rear end of the first vehicle 106 at each predefined time interval. For example, if the predefined time interval is “2 seconds”, a new bounding box may be rendered after expiry of every “2 seconds” at the rear end of the front vehicle. In an alternate embodiment, size of the same bounding box rendered at the rear end of the first vehicle 106 may be varied at expiry of each predefined time interval based on distance of the first vehicle 106 from the autonomous vehicle 104. The autonomous vehicle 104 may analyse size of one or more bounding boxes rendered at the rear end of the first vehicle 106 and may determine the area of each of the one or more bounding boxes. This process is performed continuously. The area of the bounding box may decrease, or increase based on movement of the autonomous vehicle 104 with respect to the first vehicle 106.

The autonomous vehicle 104 may compare size of bounding boxes rendered at consecutive time intervals to determine whether distance between the first vehicle 106 and the autonomous vehicle 104 is increasing or decreasing. If relative size of the consecutive bounding box decreases, it implies that the distance between the first vehicle 106 and the autonomous vehicle 104 is increasing. In contrast, if the relative size of the consecutive bounding box increases, it implies that the distance between the first vehicle 106 and the autonomous vehicle 104 is decreasing. In other words, the autonomous vehicle 104 is nearing the first vehicle 106. In an alternate embodiment, the autonomous vehicle 104 may compare area of bounding boxes rendered at consecutive time intervals to determine whether distance between the first vehicle 106 and the autonomous vehicle 104 is increasing or decreasing. In addition to determining the plurality of separation distances, a current velocity of the autonomous vehicle 104 and the first vehicle 106 may be determined via one or more of the plurality of sensors 204.

Based on continuous monitoring of the dynamic separation distance and the current velocity, a trigger may be generated for the autonomous vehicle 104 to overtake the first vehicle at step 404. The trigger may be generated when the dynamic separation distance at a current time instance is below a first distance threshold and the current velocity of the autonomous vehicle 104 is greater than the current velocity of the first vehicle 106. The first distance threshold may correspond to a minimum distance that must be maintained between the autonomous vehicle 104 and the first vehicle 106. Additionally, the autonomous vehicle 104 may adjust its current velocity in order to maintain a pre-decided safe distance from the first vehicle 106.

Once the trigger is generated, at step 406, an overtaking velocity and an overtaking distance is determined for the autonomous vehicle 104 based on the plurality of separation distances determined at the predefined time intervals, over the period of time. An exemplary method for determining the overtaking velocity of the autonomous vehicle 104 is explained in detail in conjunction with FIG. 5. Once the overtaking velocity of the autonomous vehicle 104 is determined, in an exemplary embodiment, the overtaking distance for the autonomous vehicle 104 may be determined based on the equation (1) given below:

D=T*V_{agr} (1)
Where,
D=Overtaking Distance
T=Time
V_{agr}=Overtaking Velocity of the autonomous vehicle 104.

Based on the overtaking velocity and the overtaking distance determined, the autonomous vehicle 104 may overtake the first vehicle 106 within the period of Time ‘T’. It may be noted that the distance ‘D’ may change, i.e., increase or decrease, depending on the current velocity of the first vehicle 106 (for example, due to slow down of the first vehicle 106 on the first lane).

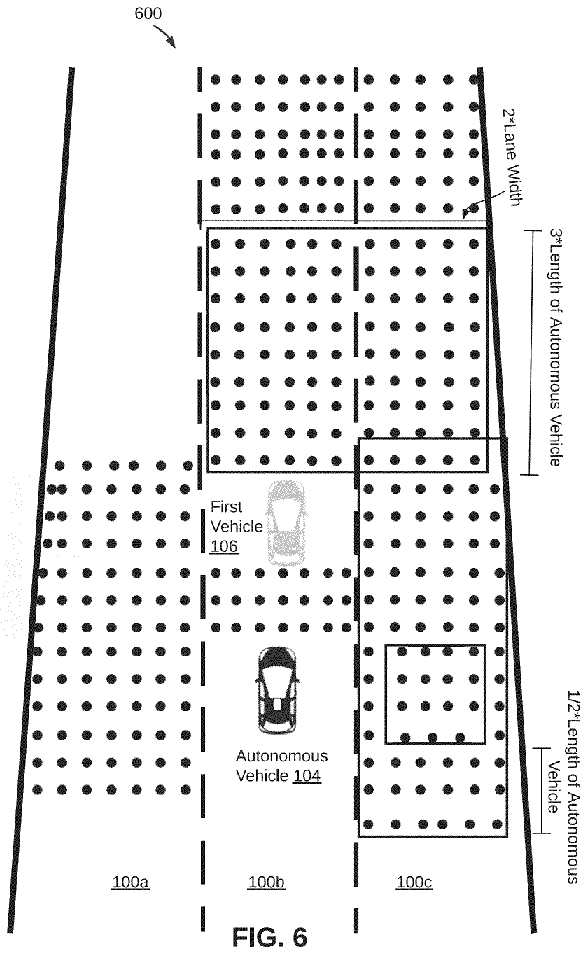

Once the overtaking velocity and the overtaking distance is determined, an available overtaking region is determined for the autonomous vehicle 104 at step 408. The available overtaking region may be determined based on a region ahead of the first vehicle 106 on the first lane (for example, the lane 100b). The available overtaking region may additionally be determined based on one or more dimension features associated with one or more adjacent lanes (for example, the lanes 100a and 100c). The one or more dimension features may be generated based on a set of parameters received from at least one of the plurality of sensors. The one or more dimension features may include a multiple of the length of the autonomous vehicle 104 in an adjacent lane and a width of at least one lane from one of the adjacent lanes. This is further explained in detail in conjunction with an exemplary embodiment of FIG. 6.

In an embodiment, the autonomous vehicle 104 may perform multiple perception estimation about a road region, in order to identify the available overtaking region and the region ahead of the first vehicle 106. This may be done primarily with a LIDAR sensor. The LIDAR sensor may be fitted on top of the autonomous vehicle 104, such that, the LIDAR sensor is on an elevation slightly higher than roof of the autonomous vehicle 104. This enables the LIDAR sensor to provide image of surroundings far beyond the autonomous vehicle 104. The LIDAR sensor may generate a plurality of LIDAR points on a free road region available for overtaking. These LIDAR points are filtered in such a way that a set of LIDAR points with lowest elevation may be retained from the plurality of LIDAR points. By retaining only the set of LIDAR points with lowest elevation, all other LIDAR point reflections other than from highway road surface may be filtered to a LIDAR point cloud. Thereafter, the set of LIDAR points may be processed for understanding a future road availability for the autonomous vehicle 104.

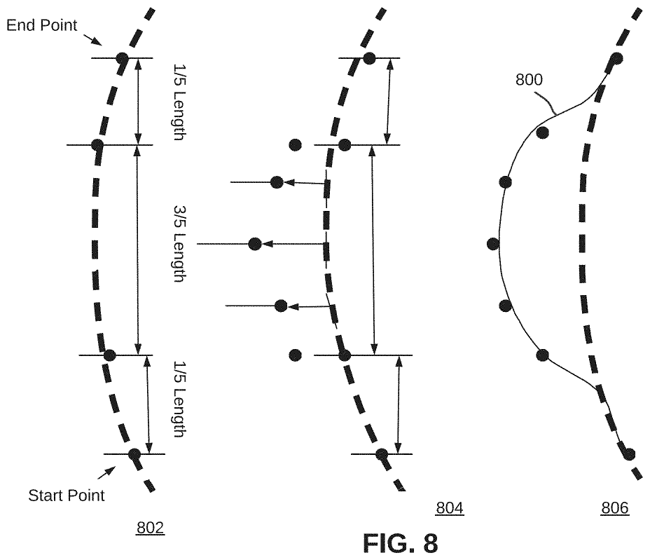

Once the available overtaking region is determined, a trajectory may be generated for the autonomous vehicle 104 to overtake the first vehicle 106 at step 410, when the available overtaking region is above a second distance threshold. The second distance threshold may correspond to a predefined threshold associated with one or more parameters from the set of trajectory parameters. The set of trajectory parameters may include one or more of, but is not limited to a slope of the trajectory, an alignment of the trajectory, a curvature of the trajectory, and a road roughness of the trajectory. The trajectory may be a trapezoidal trajectory. In other words, the shape of the trajectory may be trapezoidal. The trajectory may include a plurality of portions and a first portion from the plurality of portions is at a predefined distance from the first lane. The method of generating the trajectory is explained in detail in conjunction with an exemplary embodiment given in FIG. 8.

Referring now to FIG. 5, determination of overtaking velocity and an overtaking distance based on a graph 500 that represents separation distance versus time for the autonomous vehicle 104 and the first vehicle 106 is illustrated, in accordance with an exemplary embodiment. The separation distance versus time graph 500 may be used to derive information related to a possibility for overtaking the first vehicle 106 by the autonomous vehicle 104.

The autonomous vehicle 104 and the first vehicle 106 are assumed to be on a path (x2, y2) of the graph 500. The graph 500 represents a separation distance on X-axis and a pre-defined time interval for separation on Y-axis. A slope ‘S1’ and a slope ‘S2’ represents a rate of change of separation of the autonomous vehicle 104 from the first vehicle 106. The slope ‘S1’ depicts increase in relative velocity of the autonomous vehicle 104 determined based on a sudden decrease in the separation distance of the autonomous vehicle 104 and the first vehicle 106, monitored at time ‘t=1’. Thereafter, the slope ‘S2’ may represent further increase in the relative velocity of the autonomous vehicle 104 based on a further decrease in the separation distance of the autonomous vehicle 104 and the first vehicle 106, monitored at time ‘t=2’.

Based on the rate of change of separation monitored at the predefined time intervals over a period of time, the autonomous vehicle 104 may generate a trigger to overtake the first vehicle 106. The trigger may be generated when the rate of change of separation may be ‘K’ times an average slope of the relative velocity of the autonomous vehicle 104 resulting from the reducing separation. ‘K’ may corresponds to a predefined constant. In order to determine an overtaking velocity for the autonomous vehicle 104, such that, it is able to overtake the first vehicle 106, an average slope ‘sk’ may be determined based on equation (2) below:

‘sk’=K*(s2+s3)/2 (2)
Where each of s2, s3, sk is calculated as
sx=(separation increased or decreased)/(time gap)

The average slope ‘sk’ may represent the overtaking velocity of the autonomous vehicle 104. The overtaking velocity thus determined is then used to determine the overtaking distance using the equation (1).

Referring now to FIG. 6, a LIDAR point reflection representing availability of a free road region for overtaking the first vehicle 106 by the autonomous vehicle 104 is illustrated, in accordance with an embodiment. FIG. 6 represents a top view of movement of the autonomous vehicle 104 on a highway along with corresponding LIDAR point reflection on the highway. In order to initiate overtaking, the free region ahead of the first vehicle 106 may include at least below mentioned dimensions as represented by equation (3) and (4):

Length=3*(Length of the autonomous vehicle 104) (3)

Width=2*Lane Width (4)

Since the width is twice the lane width, the width may cover the first lane (the lane 100b) and may also extend over one of the adjacent lanes, i.e., either the left lane (the lane 100a) or the right lane (the lane 100c). In FIG. 6, the width covers the first lane (the lane 100b) and the lane 100c. As depicted in FIG. 6, the overall free road region may be determined as a four coordinate rectangle covers the lane 100b and the lane 100c and must be empty. Dimensions of the four coordinate rectangle may be such that one side is equal to the length as given in equation 3 and the second side is equal to the width as given in equation 4. The four coordinate rectangle may need to be extended length wise by the LIDAR points cluster, such that the LIDAR points touches the free road region ahead of the first vehicle 106. Additionally, the LIDAR points may be required to extended back at least up to half length of the autonomous vehicle 104 (as depicted in FIG. 6) for a while after the trigger for overtaking is generated. This may indicate that no high-speed vehicle may come in close proximity to the autonomous vehicle 104 on the adjacent lane, i.e., the lane 100c, while the autonomous vehicle 104 is performing the overtaking maneuver.

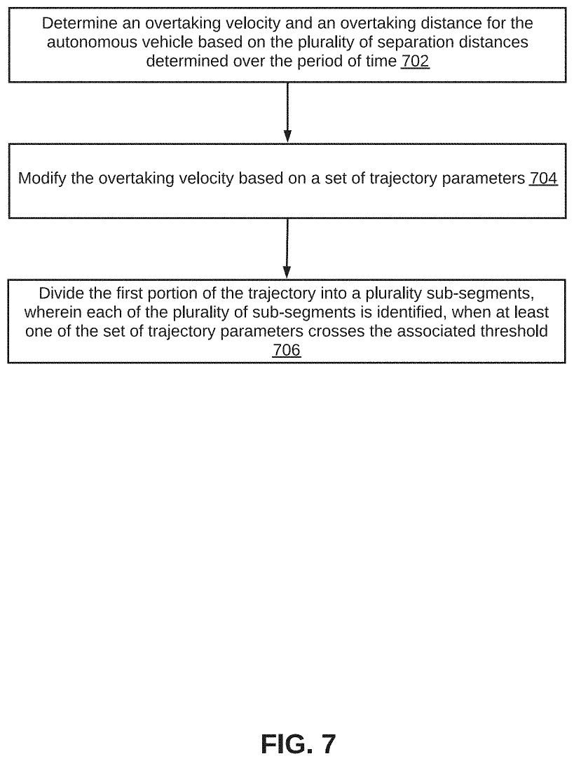

Referring now to FIG. 7, a flowchart of a method for modifying an overtaking velocity of the autonomous vehicle 104 while overtaking the first vehicle 106 is illustrated, in accordance with an embodiment. At step 702, an overtaking velocity and an overtaking distance may be determined for the autonomous vehicle 104 based on a plurality of separation distances determined over a period of time. The method for determining the overtaking velocity and the overtaking distance have already been explained in detail in conjunction with FIG. 4, FIG. 5, and FIG. 6. Thereafter, at step 704, the overtaking velocity is modified based on a set of trajectory parameters. The set of trajectory parameters may include one or more of, but is not limited to a slope of the trajectory, an alignment of the trajectory, a curvature of the trajectory, and a road roughness of the trajectory. In other words, the modified overtaking velocity is a function of one or more of the slope, the alignment, the curvature, and the road roughness associated with the trajectory. It may be noted that values of the set of trajectory parameters may be determined by one or more of the plurality of sensors.

In an embodiment, the trajectory may include a plurality of portions. A first portion from the plurality of portions is at a predefined distance from the first lane (i.e., the lane 100b). In other words, the first portion may lie in an adjacent lane (for example, the lane 100c). Further, a second portion of the trajectory initiates from a source location of the autonomous vehicle 104 and culminates at the start of the first portion. In a similar manner, a third portion of the trajectory may initiate from a culmination point of the first portion and culminates at a target location for the autonomous vehicle 104, such that, the target location is ahead of the first vehicle 106 on the first lane.

The overtaking velocity may be modified while the autonomous vehicle 104 is traversing the first portion of the trajectory. The overtaking velocity may be modified when one or more of the set of trajectory parameters cross an associated threshold. For a given trajectory parameter, the associated threshold may correspond to a predefined threshold value for that trajectory parameter. In an exemplary embodiment, each of the equations (5), (6), (7) and (8) given below represents a formula for determining modified value of the overtaking velocity of the autonomous vehicle 104 for each trajectory parameter:

Down slope (θ)=Vo*1.3*Cos θ (5)

Up slope (Ø)=Vo*0.6*Cos Ø (6)

Curvature OR Turning radius (R)=Vo*(2/R) (7)

Road Roughness Factor (K)=K* (8)

In each of the equations (5), (6), (7) and (8), ‘Vo’ represents the original overtaking velocity determined for overtaking the first vehicle 106 ahead of the autonomous vehicle 104. Each of the equations (5), (6), (7) and (8) represents formulas that may be used to compute modified overtaking velocity based on each of the set of trajectory parameters. By way of an example, when the down slope (θ) of the trajectory crosses an associated threshold, the modified overtaking velocity may be determined based on the formula: Vo*1.3*Cos θ as represented by the equation (5). This modified overtaking velocity for the down slope may be a maximum overtaking velocity that the autonomous vehicle 104 may need to follow. Additionally, at step 708, the first portion of the trajectory may be divided into a plurality sub-segments. Each of the plurality of sub-segments of the trajectory is identified, when one or more of the set of trajectory parameters cross the associated threshold. Thus, the modified overtaking velocity of the autonomous vehicle 104 may be determined for each of the plurality of sub-segments. In other words, overtaking velocity of the autonomous vehicle 104 may vary for each of the plurality of sub-segments.

Referring now to FIG. 8, determination of a trapezoidal overtaking trajectory 800 for the autonomous vehicle 104 with respect to a base global path is illustrated in accordance with an exemplary embodiment. FIG. 8 may represent an inflation of a base global path with a start point and an end point. As represented by 802, the start point may correspond to an initial current position of the autonomous vehicle 104 and the end point may correspond to a final point or destination point that the autonomous vehicle 104 may reach after overtaking the first vehicle 106. The trapezoidal overtaking trajectory 800 may be planned based on a length of the base global path. The length of the base global path may be equal to the overtaking distance determined using the equation 1. In order to determine the trapezoidal overtaking trajectory 800, the length of the base global path may be divided into three segment that may include an first ⅕^{th} length segment, a ⅗^{th} length segment, and a second ⅕^{th} length segment.

As explained in FIG. 7, the trapezoidal overtaking trajectory 800 includes a first portion, a second portion, and a third portion. It may be noted that the ⅗^{th} length segment of the base global path corresponds to the first portion of the trapezoidal overtaking trajectory 800, which may not have a fixed length. Similarly, the first ⅕^{th} length segment of the base global path corresponds to the second portion of the trapezoidal overtaking trajectory 800 and the second ⅕^{th} length segment of the base global path corresponds to the third portion of the trapezoidal overtaking trajectory 800.

The ⅗^{th} length segment of the base global path may further be divided into a plurality of sub-segments as represented at 804. Each of the plurality of sub-segments may correspond to a waypoint on the base global path. The waypoint corresponds to a stopping place on the base global path. By way of an example, an alignment of every two waypoints may be determined for the ⅗^{th} length segment of the base global path. Based on the alignment of the two waypoints determined, an imaginary line is drawn perpendicular from any one of the two waypoints. Once the perpendicular line is drawn, a point is determined on the perpendicular line at a distance ‘d’ from the waypoint of the base global path. The distance ‘d’ may correspond to an average lane width. Once multiple such points are determined at a distance ‘d’ from the respective waypoints, an imaginary line connecting these multiple points, the start point, and the end point is drawn to form the trapezoidal overtaking trajectory 800 as depicted in 806.

As determined in many different scenarios the autonomous vehicle 104 may chase a distance in parallel to the first vehicle 106, and hence the ⅗^{th} length segment is called a chasing segment. Moreover, the ⅗^{th} length segment may be dynamically divided into multiple segments based on capability of motion of the autonomous vehicle 104 for different road scenarios. The different road scenarios may be based on a set of trajectory parameters. In other words, the number of sub-segments that the ⅗^{th} length segment is divided into, may depend on the number of time one or more of a set of trajectory parameters cross an associated threshold. The set of trajectory parameters may be determined based on a last generated trajectory for the autonomous vehicle 104. The set of trajectory parameters may include one or more of but is not limited to a slope of a trajectory, an alignment of the trajectory, a curvature of the trajectory, and a road roughness of the trajectory.

As explained before in FIG. 7, based on the set of trajectory parameters determined, for each waypoint of the ⅗^{th} length segment, a different (modified) overtaking velocity may be generated. The autonomous vehicle 104 maintains the modified velocity for each of the plurality of sub-segments. Once it is determined that the autonomous vehicle 104 may use the trapezoidal overtaking trajectory 800 for the complete bypass stretch, a trigger is generated for the autonomous vehicle 104 to initiate motion on the trapezoidal overtaking trajectory 800.

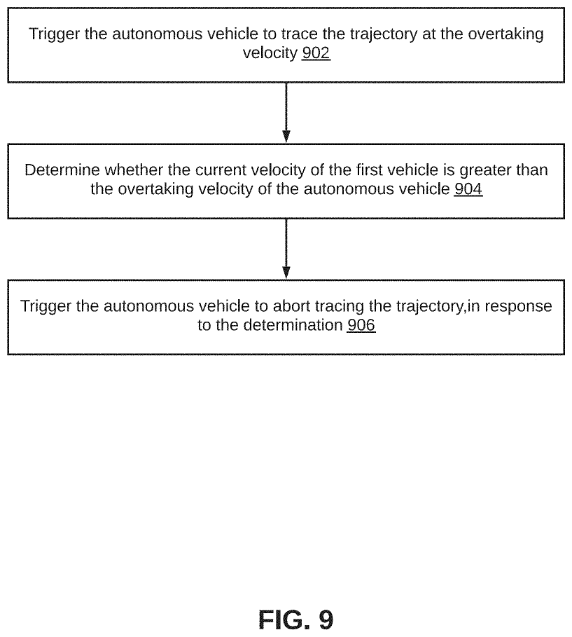

Referring now to FIG. 9, a flowchart of a method for determining a trigger to abort overtaking maneuver by the autonomous vehicle 104 is illustrated, in accordance with an embodiment. At step 902, a trigger is generated for the autonomous vehicle 104 to trace a trajectory at the overtaking velocity in order to overtake the first vehicle 106. Thereafter, at step 904, it is determined whether the current velocity of the first vehicle 106 is greater than the overtaking velocity of the autonomous vehicle 104. If the current velocity of the first vehicle 106 is determined to be greater than the overtaking velocity of the autonomous vehicle 104, a trigger may be generated for the autonomous vehicle 104 to abort tracing the trajectory for overtaking at step 906.

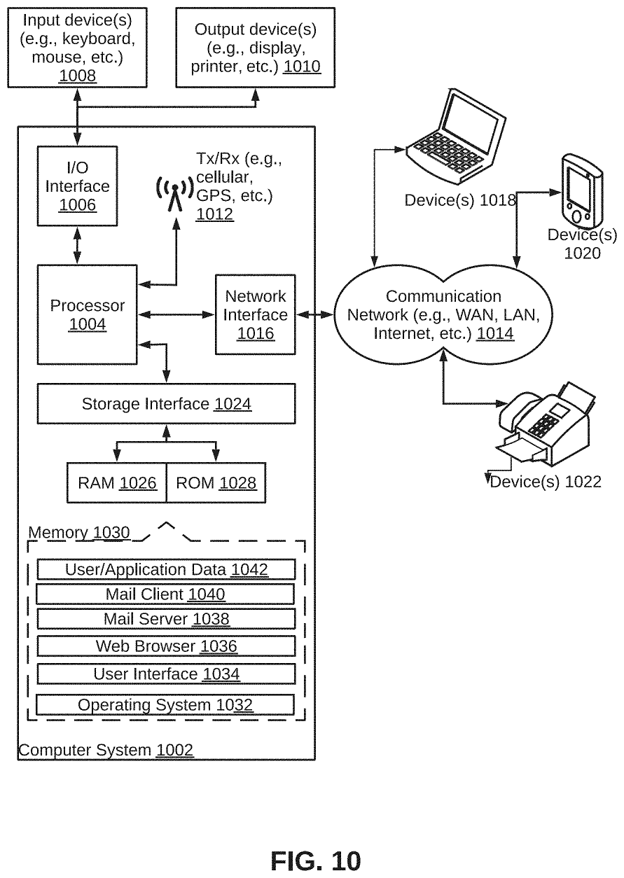

Referring now to FIG. 10, a block diagram of an exemplary computer system 1002 for implementing various embodiments is illustrated. Computer system 1002 may include a central processing unit (“CPU” or “processor”) 1004. Processor 1004 may include at least one data processor for executing program components for executing user or system-generated requests. A user may include a person, a person using a device such as such as those included in this disclosure, or such a device itself. Processor 1004 may include specialized processing units such as integrated system (bus) controllers, memory management control units, floating point units, graphics processing units, digital signal processing units, etc. Processor 1004 may include a microprocessor, such as AMD® ATHLOM® microprocessor, DURON® microprocessor OR OPTERON® microprocessor ARM's application, embedded or secure processors, IBM® POWERPC®, INTEL'S CORE® processor, ITANIUM® processor, XEON® processor, CELERON® processor or other line of processors, etc. Processor 1004 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1004 may be disposed in communication with one or more input/output (I/O) devices via an I/O interface 1006. I/O interface 1006 may employ communication protocols/methods such as, without limitation, audio, analog, digital, monoau al, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM long-term evolution (LTE), WiMax, or the like), etc.

Using I/O interface 1006, computer system 1002 may communicate with one or more I/O devices. For example, an input device 1008 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 1010 may be a printer, fax machine, video display (for example, cathode ray tube (CRT), liquid crystal display (LCD), light-emitting diode (LED), plasma, or the like), audio speaker, etc. In some embodiments, a transceiver 1012 may be disposed in connection with processor 1004. Transceiver 1012 may facilitate various types of wireless transmission or reception. For example, transceiver 1012 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 1004 may be disposed in communication with a communication network 1014 via a network interface 1016. Network interface 1016 may communicate with communication network 1014. Network interface 1016 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 1014 may include, without limitation, a direct interconnection, local area network (LAN), wide area network (WAN), wireless network (for example, using Wireless Application Protocol), the Internet, etc. Using network interface 1016 and communication network 1014, computer system 1002 may communicate with devices 1018, 1020, and 1022. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® reader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 1002 may itself embody one or more of these devices.

In some embodiments, processor 1004 may be disposed in communication with one or more memory devices (for example, RAM 1026, ROM 1028, etc.) via a storage interface 1024. Storage interface 1024 may connect to memory 1030 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 1030 may store a collection of program or database components, including, without limitation, an operating system 1032, user interface application 1034, web browser 1036, mail server 1038, mail client 1040, user/application data 1042 (for example, any data variables or data records discussed in this disclosure), etc. Operating system 1032 may facilitate resource management and operation of computer system 1002. Examples of operating systems 1032 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 1034 may facilitate display, execution, interaction, manipulation, or operation of program components through textual or graphical facilities. For example, user interfaces may provide computer interaction interface elements on a display system operatively connected to computer system 1002, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 1002 may implement a web browser 1036 stored program component. Web browser 1036 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APIs), etc. In some embodiments, computer system 1002 may implement a mail server 1038 stored program component. Mail server 1038 may be an Internet mail server such as MICROSOFT® EXCHANGE® mail server, or the like. Mail server 1038 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 1038 may utilize communication protocols such as internet message access protocol (IMAP), messaging application programming interface (MAPI), Microsoft Exchange, post office protocol (POP), simple mail transfer protocol (SMTP), or the like. In some embodiments, computer system 1002 may implement a mail client 1040 stored program component. Mail client 1040 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 1002 may store user/application data 1042, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide method and system for determining an overtaking trajectory for autonomous vehicles. The method and system monitor a dynamic separation distance of an autonomous vehicle from a first moving vehicle ahead of the autonomous vehicle so as to identify a need for overtaking. The method and system may then determine an available overtaking region and an overtaking velocity required by the autonomous vehicle for overtaking the first vehicle. Thereafter, the method and system may generate a trapezoidal trajectory that may be followed by the autonomous vehicle in order to overtake the first vehicle ahead of the autonomous vehicle. The benefit of the invention is that, this invention does not allow road blocking and confusion for other vehicles on the road. Moreover, a strategy for determining the trapezoidal trajectory is time-bound, rather than distance-bound. Furthermore, the invention may render the autonomous vehicle motion design in a more sensitive way for an evolving road circumstance due to road form (turn, etc.), and road vehicle speed shift.

The specification has described method and system for determining an overtaking trajectory for autonomous vehicles. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant arts) based on the teachings contained herein. Such alternatives fall within the scope and spirit of the disclosed embodiments,

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining an overtaking trajectory for autonomous vehicles, the method comprising:
determining, by a trajectory determining device, a plurality of dynamic separation distances of an autonomous vehicle from a first vehicle ahead of the autonomous vehicle at predefined time intervals over a period of time, wherein the first vehicle and the autonomous vehicle are on a first lane;
generating, by the trajectory determining device, a trigger for the autonomous vehicle to overtake the first vehicle, when the dynamic separation distance at a current time instance is below a first distance threshold and a current velocity of the autonomous vehicle is greater than a current velocity of the first vehicle;
determining, by the trajectory determining device, an overtaking velocity and an overtaking distance for the autonomous vehicle based on the plurality of separation distances determined over the period of time;
determining, by the trajectory determining device, an available overtaking region for the autonomous vehicle, based on at least one dimension feature associated with at least one adjacent lane and a region ahead of the first vehicle on the first lane, wherein the at least one dimension feature is generated based on a set of parameters received from at least one of a plurality of sensors; and
generating, by the trajectory determining device, a trajectory for the autonomous vehicle to overtake the first vehicle based on the overtaking distance, when the available overtaking region is above a second distance threshold, wherein the trajectory comprises a plurality of portions and a first portion from the plurality of portions is at a predefined distance from the first lane.

2. The method of claim 1, wherein the plurality of dynamic separation distances are determined based on size of at least one bounding box rendered at a rear end of the first vehicle at the predefined time intervals over the period of time

3. The method of claim 1 further comprising triggering the autonomous vehicle o trace the trajectory at the overtaking velocity.

4. The method of claim 3, further comprising:
determining whether the current velocity of the first vehicle is greater than the overtaking velocity of the autonomous vehicle;
triggering the autonomous vehicle to abort tracing the trajectory, in response to the determination, wherein the triggering further comprises generating an abort trajectory or the autonomous vehicle, wherein the abort trajectory culminates behind the first vehicle on the first lane.

5. The method of claim 1 further comprising modifying the overtaking velocity based on a set of trajectory parameters, wherein the set of trajectory parameters comprises at least one of a slope of the trajectory, an alignment of the trajectory, a curvature of the trajectory, and a road roughness of the trajectory, and wherein the modified overtaking velocity is a function of at least one of the slope, the alignment, the curvature, and the road roughness.

6. The method of claim 5, wherein the overtaking velocity is modified while traversing the first portion of the trajectory, when at least one of the set of trajectory parameters crosses an associated threshold.

7. The method of claim 6, further comprising dividing the first portion of the trajectory into a plurality sub-segments, wherein each of the plurality of sub-segments is identified, when at least one of the set of trajectory parameters crosses the associated threshold.

8. The method of claim 1, wherein,
a second portion from the plurality of portions initiates from a source location of the autonomous vehicle and culminates at the start of the first portion, and
a third portion from the plurality of portions initiates from a culmination point of the first portion and culminates at a target location for the autonomous vehicle, and wherein the target location is ahead of the first vehicle on the first lane.

9. The method of claim 1, wherein the plurality of sensors comprises at least one of a vision sensor, an Autonomous Vehicle (AV) sensor, a LIDAR (Light Detection and Ranging), an Inertial Measurement Unit (IMU), and an ultrasound sensor.

10. A system for determining an overtaking trajectory for autonomous vehicles, the system comprising:
a processor; and
a memory communicatively coupled to the processor, wherein the memory stores processor instructions, which, on execution, causes the processor to:
determine a plurality of dynamic separation distances of an autonomous vehicle from a first vehicle ahead of the autonomous vehicle at predefined time intervals over a period of time, wherein the first vehicle and the autonomous vehicle are on a first lane;
generate a trigger for the autonomous vehicle to overtake the first vehicle, when the dynamic separation distance at a current time instance is below a first distance threshold and a current velocity of the autonomous vehicle is greater than a current velocity of the first vehicle;
determine an overtaking velocity and an overtaking distance for the autonomous vehicle based on the plurality of separation distances determined over the period of time;
determine an available overtaking region for the autonomous vehicle, based on at least one dimension feature associated with at least one adjacent lane and a region ahead of the first vehicle on the first lane, wherein the at least one dimension feature is generated based on a set of parameters received from at least one of a plurality of sensors; and
generate a trajectory for the autonomous vehicle to overtake the first vehicle based on the overtaking distance, when the available overtaking region is above a second distance threshold, wherein the trajectory comprises a plurality of portions and a first portion from the plurality of portions is at a predefined distance from the first lane.

11. The system of claim 10, wherein the plurality of dynamic separation distances are determined based on size of at least one bounding box rendered at a rear end of the first vehicle at the predefined time intervals over the period of time.

12. The system of claim 10, wherein the processor instructions further cause the processor to trigger the autonomous vehicle to trace the trajectory at the overtaking velocity.

13. The system of claim 12, wherein the processor instructions further cause the processor to:
determine, whether the current velocity of the first vehicle is greater than the overtaking velocity of the autonomous vehicle;
trigger the autonomous vehicle to abort tracing the trajectory, in response to the determination, wherein the triggering further comprises generating an abort trajectory or the autonomous vehicle, wherein the abort trajectory culminates behind the first vehicle on the first lane.

14. The system of claim 1, wherein the processor instructions further cause the processor to modify the overtaking velocity based on a set of trajectory parameters, wherein the set of trajectory parameters comprises at least one of a slope of the trajectory, an alignment of the trajectory, a curvature of the trajectory, and a road roughness of the trajectory, and wherein the modified overtaking velocity is a function of at least one of the slope, the alignment, the curvature, and the road roughness.

15. The system of claim 14, wherein the overtaking velocity is modified while traversing the first portion of the trajectory, when at least one of the set of trajectory parameters crosses an associated threshold.

16. The system of claim 15, wherein the processor instructions further cause the processor to divide the first portion of the trajectory into a plurality sub-segments, wherein each of the plurality of sub-segments is identified, when at least one of the set of trajectory parameters crosses the associated threshold.

17. The system of claim 10, wherein the processor instructions further cause the processor to:
a second portion from the plurality of portions initiates from a source location of the autonomous vehicle and culminates at the start of the first portion, and
a third portion from the plurality of portions initiates from a culmination point of the first portion and culminates at a target location for the autonomous vehicle, and wherein the target location is ahead of the first vehicle on the first lane.

18. The system of claim 10, where in the plurality of sensors comprises at least one of a vision sensor, an Autonomous Vehicle (AV) sensor, a LIDAR (Light Detection and Ranging),an Inertial Measurement Unit (IMU) sensor, and an ultrasound sensor.

19. A non-transitory computer-readable storage medium for determining an overtaking trajectory for autonomous vehicles, having stored thereon, a set of computer-executable instructions causing a computer comprising one or more processors to perform steps comprising:
determining a plurality of dynamic separation distances of an autonomous vehicle from a first vehicle ahead of the autonomous vehicle at predefined time intervals over a period of time, wherein the first vehicle and the autonomous vehicle are on a first lane;
generating a trigger for the autonomous vehicle to overtake the first vehicle, when the dynamic separation distance at a current time instance is below a first distance threshold and a current velocity of the autonomous vehicle is greater than a current velocity of the first vehicle;
determining an overtaking velocity and an overtaking distance for the autonomous vehicle based on the plurality of separation distances determined over the period of time;
determining an available overtaking region for the autonomous vehicle, based on at least one dimension feature associated with at least one adjacent lane and a region ahead of the first vehicle on the first lane, wherein the at least one dimension feature is generated based on a set of parameters received from at least one of a plurality of sensors; and
generating a trajectory for the autonomous vehicle to overtake the first vehicle based on the overtaking distance, when the available overtaking region is above a second distance threshold, wherein the trajectory comprises a plurality of portions and a first portion from the plurality of portions is at a predefined distance from the first lane.
